(19) United States
(12) Patent Application Publication
(10) Pub. No.: US 2026/0066455 A1
(43) Pub. Date: Mar. 5, 2026

(54) ENERGY STORAGE SYSTEM

(71) Applicant: SAMSUNG SDI CO., LTD., Yongin-si (KR)

(72) Inventor: Hee Tae SON, Suwon-si (KR)

(21) Appl. No.: 19/303,505

(22) Filed: Aug. 19, 2025

(30) Foreign Application Priority Data
Sep. 2, 2024 (KR) 10-2024-0118629

(51) Int. Cl. H01M 50/383; H01M 50/209; H01M 50/342; H01M 50/358; H01M 50/367

(52) U.S. Cl. CPC H01M 50/383; H01M 50/209; H01M 50/3425; H01M 50/358; H01M 50/367; H01M 2200/20

(57) ABSTRACT

An energy storage system includes a rack, a battery module in the rack, the battery module including a module case and a module vent part, a plurality of battery cells disposed in the module case, each of the plurality of battery cells including a cell vent part which communicates with the module vent part, and a flame removal module part in the rack, the flame removal part including a flame removal module which communicates with the module vent part.

### CROSS-REFERENCE TO RELATED APPLICATION

The present application claims priority and the benefit of Korean Patent Application No. 10-2024-0118629, filed on Sep. 2, 2024, in the Korean Intellectual Property Office, the entire disclosure of which is incorporated herein by reference.

### BACKGROUND

### 1. Field

The present disclosure relates to an energy storage system.

### 2. Description of the Related Art

In general, an energy storage system (ESS) is a system capable of storing surplus electricity or electricity generated using renewable energy. An energy storage system may include a plurality of battery modules installed in a rack. The battery module may include a plurality of secondary batteries which are electrically connected to each other and may be combined in any of various structures.

Secondary batteries are widely used for driving or storing energy not only in small apparatuses such as portable electronic devices but also in medium-to-large apparatuses such as electric vehicles or ESSs. In particular, in the case of medium-to-large apparatuses, a plurality of battery cells are electrically connected to form one battery module in order to improve an output power and a capacity of a battery.

An event such as a fire may occur in a battery cell disposed in a battery module, and when the fire occurs in the battery cell, a flame may spread to an adjacent battery cell, and thus thermal runaway can occur. Since a plurality of battery modules may be disposed in a rack, a risk of thermal runaway can be high.

The above information disclosed in this Background section is provided for enhancement of understanding of the background of the present disclosure, and, therefore, it may contain information that does not constitute related or prior art.

### SUMMARY

Embodiments include an energy storage system, including a rack, a battery module in the rack, the battery module including a module case and a module vent part, a plurality of battery cells in the module case, each of the plurality of battery cells including a cell vent part which communicates with the module vent part, and a flame removal module part in the rack, the flame removal part including a flame removal module which communicates with the module vent part.

The battery module may include a module case hole provided as an opening passing through the module case, the module case hole being blocked from the module vent part.

The module vent part may include a module vent coupling part which communicates with the cell vent part, a module vent passage which communicates with the module vent coupling part, and a module vent discharge part on an end portion of the module vent passage, the module vent discharge part in communication with the flame removal module.

The battery module may include a plurality of battery modules, and the flame removal module part communicates with the module vent part included in each of the plurality of battery modules.

The flame removal module part may include a flame inlet which communicates with the module vent part, and a flame connection part which communicates with the flame inlet.

The flame removal module part may include a plurality of flame removal modules, and adjacent flame removal modules may communicate with each other through the flame connection part.

The flame inlet may include a flame inflow hole through which a fluid moves from the module vent part to the flame removal module, and a flame inflow gate which opens or closes the flame inflow hole.

The flame inflow gate may block the fluid from moving from the flame removal module to the module vent part.

The flame removal module may include a flame outlet which communicates with the flame inlet and the flame connection part, the flame outlet discharging a fluid to an outside of the flame removal module.

The flame outlet may include a flame outflow hole through which the fluid is discharged to the outside of the flame removal module, and a flame outflow gate which opens or closes the flame outflow hole.

The flame outflow gate may open the flame outflow hole when an internal pressure of the flame removal module is lower than a set pressure and may close the flame outflow hole when an internal pressure of the flame removal module is higher than or equal to the set pressure.

The set pressure may be 1.1 bar.

The flame removal module part may include a flame prevention net in the flame removal module to remove a flame.

The flame prevention net may be in the flame inlet which communicates with the module vent part.

The flame removal module may include a plurality of flame removal modules, and the flame prevention net may be in the flame connection part through which adjacent flame removal modules communicate with each other.

The flame prevention net may be in a flame outlet through which an inside and an outside of the flame removal module communicate with each other.

These and other aspects and features of the present disclosure will be described in or will be apparent from the following description of some embodiments of the present disclosure.

### BRIEF DESCRIPTION OF THE DRAWINGS

Features will become apparent to those of ordinary skill in the art by describing in detail exemplary embodiments with reference to the attached drawings, in which:

FIG. 1 is a perspective view illustrating an energy storage system according to one or more embodiments of the present disclosure;

FIG. 2 is a perspective view illustrating a state in which a fire occurs in a battery module of the energy storage system according to one or more embodiments of the present disclosure;

FIG. 3 is a perspective view illustrating a rack and a flame removal module part of the energy storage system according to one or more embodiments of the present disclosure;

FIG. 4 is an exploded perspective view illustrating the energy storage system according to one or more embodiments of the present disclosure;

FIG. 5 is a perspective view illustrating a battery module of an energy storage system according to one or more embodiments of the present disclosure;

FIG. 6 is a cross-sectional view illustrating the battery module of the energy storage system according to one or more embodiments of the present disclosure;

FIG. 7 is a perspective view illustrating a battery cell disposed in an energy storage system according to one or more embodiments of the present disclosure;

FIG. 8 is a perspective view illustrating a flame removal module according to a first embodiment of the present disclosure;

FIG. 9 is a perspective view illustrating a plurality of flame removal modules which are connected according to the first embodiment of the present disclosure;

FIG. 10 is a perspective view illustrating a flame removal module according to a second embodiment of the present disclosure;

FIG. 11 is a perspective view illustrating a plurality of flame removal modules which are connected according to the second embodiment of the present disclosure;

FIG. 12 is a cross-sectional view illustrating a flame inlet of a flame removal module which is closed according to one or more embodiments of the present disclosure;

FIG. 13 is a cross-sectional view illustrating the flame inlet of the flame removal module which is opened according to one or more embodiments of the present disclosure;

FIG. 14 is a cross-sectional view illustrating the flame removal module connected to a battery module according to one or more embodiments of the present disclosure;

FIG. 15 is a cross-sectional view illustrating a flame outlet of a flame removal module which is opened according to one or more embodiments of the present disclosure;

FIG. 16 is a cross-sectional view illustrating the flame outlet of the flame removal module which is closed according to one or more embodiments of the present disclosure; and

FIG. 17 is a perspective view illustrating a flame prevention net disposed in a flame removal module according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Herein, some embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” when describing embodiments of the present disclosure relates to “one or more embodiments of the present disclosure. “Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element s or feature s as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented e.g., rotated 90 degrees or at other orientations, and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between and including the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same. “Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed or located or positioned on the “above or below” or “on or under” a component, it may mean that the arbitrary element is placed in contact with the upper or lower surface of the component and may also mean that another component may be interposed between the component and any arbitrary element disposed or located or positioned on or under the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

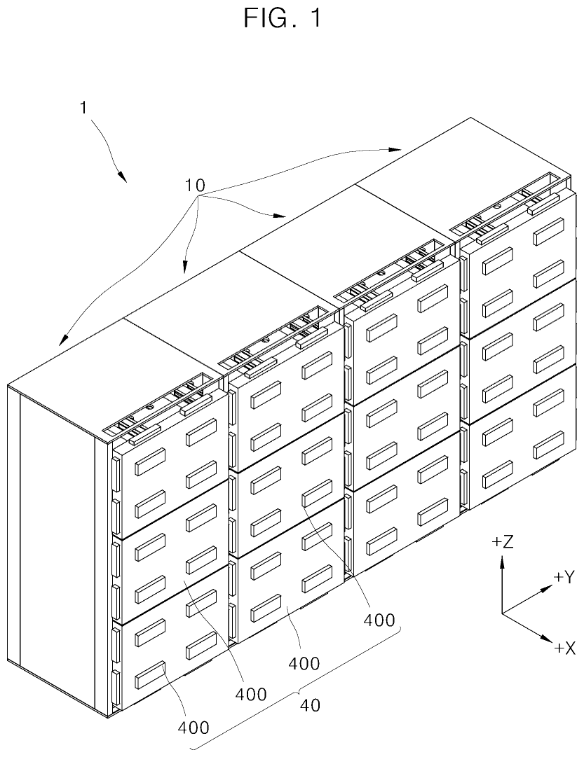

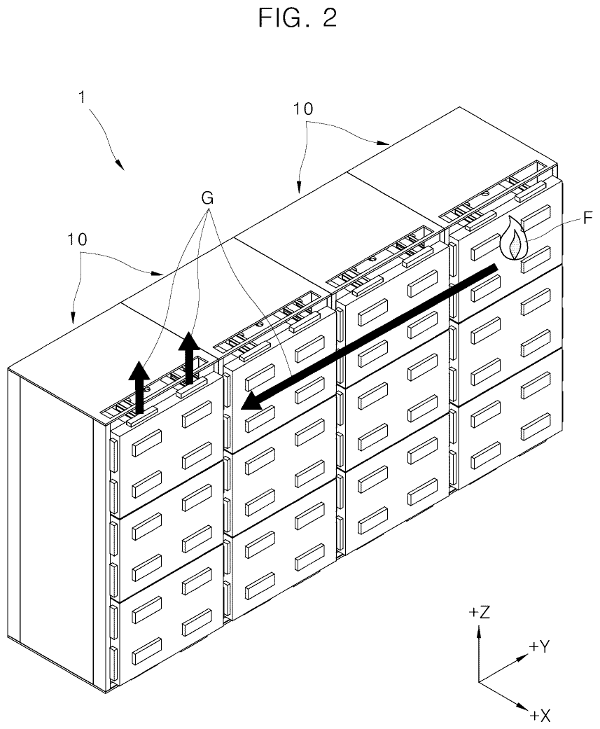

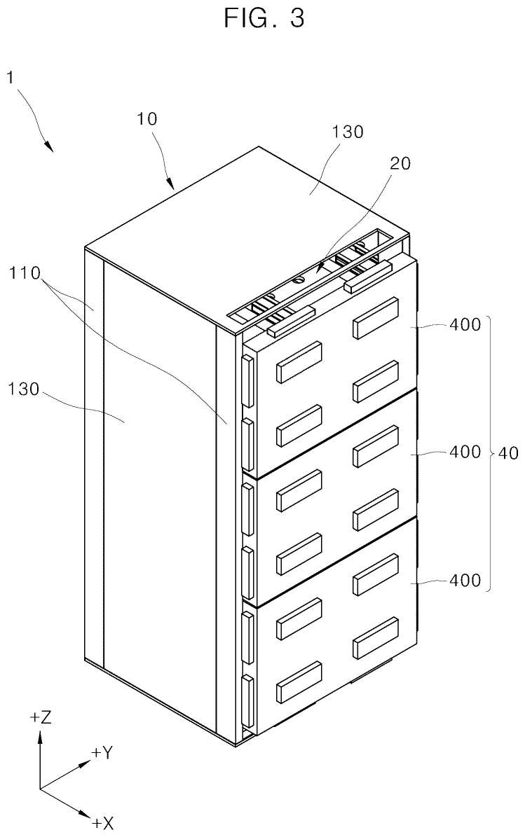

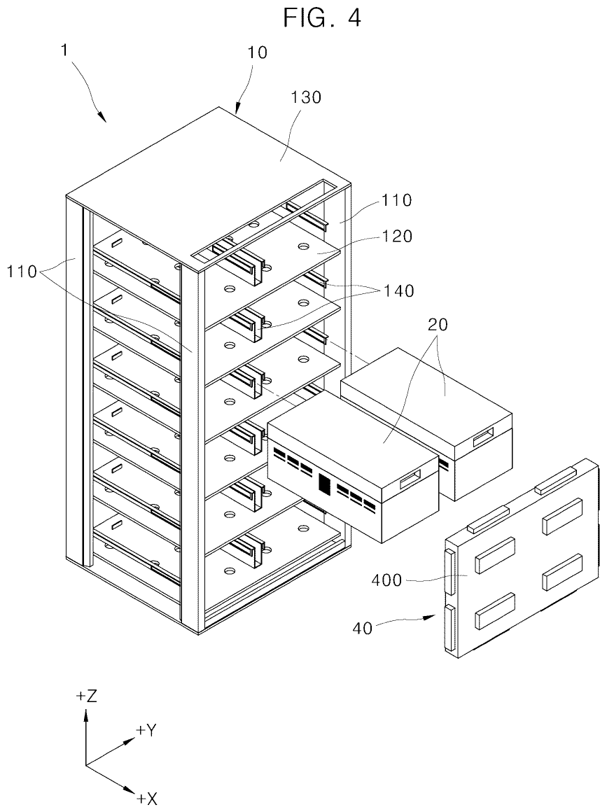

FIG. 1 is a perspective view illustrating an energy storage system according to one or more embodiments of the present disclosure, and FIG. 2 is a perspective view illustrating a state in which a fire occurs in a battery module of the energy storage system according to one or more embodiments of the present disclosure. FIG. 3 is a perspective view illustrating a rack and a flame removal module part of the energy storage system according to one or more embodiments of the present disclosure, and FIG. 4 is an exploded perspective view illustrating the energy storage system according to one or more embodiments of the present disclosure.

Hereinafter, an energy storage system 1 will be described schematically.

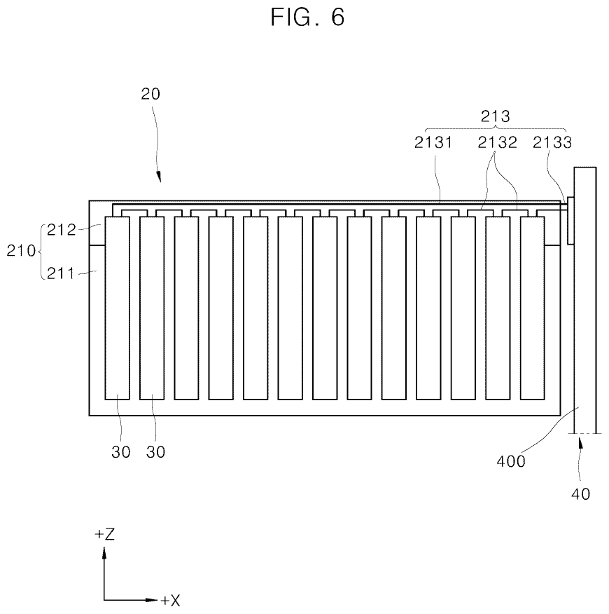

Referring to FIGS. 1 to 4, the energy storage system 1 may include a rack 10, a battery module 20, a battery cell 30 (see FIG. 6), and a flame removal module part 40.

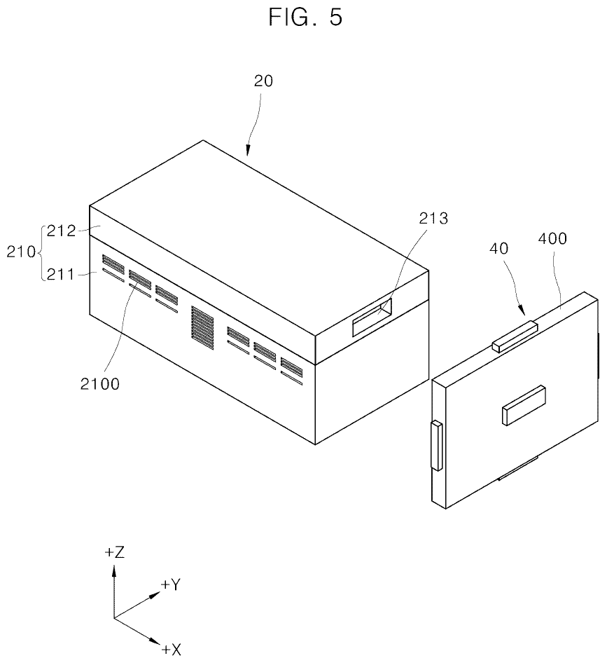

The battery cell 30 may be disposed in a module case 210 (see FIG. 5) of the battery module 20. According to one or more embodiments, a plurality of battery cells 30 may be disposed in the module case 210 to form the battery module 20. As the plurality of battery cells 30 are connected in series and/or parallel, a capacity or voltage of the battery module 20 may increase.

The battery module 20 may be disposed in the rack 10. According to one or more embodiments, a plurality of battery modules 20 may be disposed in the rack 10 to form the energy storage system 1 for storing electric energy. In some embodiments, the plurality of battery modules 20 may be disposed in one direction (for example, a Y-axis direction). In other embodiments, the plurality of battery modules 20 may be stacked in another direction (for example, a Z-axis direction). The rack 10 may be provided as a plurality of racks 10.

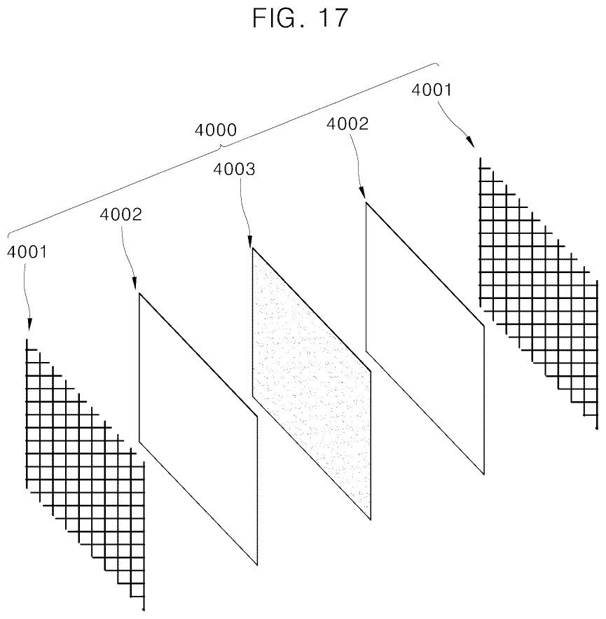

The flame removal module part 40 may include one or more flame removal modules 400. The flame removal module 400 may be disposed in the battery module 20. According to one or more embodiments, the flame removal module 400 may be disposed on a side surface (for example, in an X-axis direction) of the battery module 20. A flame and gas generated in the battery cell 30 may move to the flame removal module 400 connected to the battery module 20. A flame prevention net 4000 (see FIG. 17) may be disposed in the flame removal module 400, may lower a temperature of the flame and gas, and may remove the flame. The flame and gas may move to the flame removal module 400 and may be discharged from the flame removal module 400.

As the temperature of the flame and gas is lowered and the flame is removed by the flame removal module 400, low-temperature gas may be discharged from the flame removal module 400. Accordingly, thermal runaway in the energy storage system 1 can be prevented, and damage to the battery cell 30 and the battery module 20 can be minimized.

Hereinafter, a detailed structure of the energy storage system 1 will be described.

As shown in FIG. 4, the rack 10 may include a rack frame 110, a rack holder 120, a rack cover 130 and a rack guide 140.

The rack frame 110 may extend in one direction (for example, the Z-axis direction in the orientation shown in FIG. 4). The rack frame 110 may be provided as a plurality of rack frames 110. The rack frame 110 may be used as a structure supporting a weight of the battery module 20 disposed in the rack 10.

The rack holder 120 may be connected to the rack frame 110. According to one or more embodiments, the rack holder 120 (multiples of) may be connected to the plurality of rack frames 110. A shape of the rack holder 120 may be substantially a plate shape (e.g., a flat square as shown in FIG. 4). The rack holder 120 may be provided as a plurality of rack holders 120. The battery module 20 may be disposed on the rack holder 120. According to one or more embodiments, the plurality of battery modules 20 may be disposed on the rack holders 120.

The rack cover 130 may be disposed on an upper portion (for example, in a +Z-axis direction in the orientation shown in FIG. 4) and/or a side surface of the rack frame 110. The rack cover 130 may prevent external foreign substances from being introduced into the rack 10.

The rack guide 140 may be disposed on the rack frame 110 and/or the rack holder 120. The rack guide 140 may be in contact with the battery module 20 so that the battery module 20 may be fixed to the rack 10, and may also be removable.

The battery module 20 may be disposed in the rack 10. According to one or more embodiments, the battery module 20 may be disposed on the rack holder 120 and fixed to the rack guide 140. The flame removal module part 40 may be disposed on one side of the battery module 20. According to one or more embodiments, the battery module 20 may be connected to the flame removal module 400. The battery module 20 may communicate with the flame removal module 400, and when a fire F (see FIG. 2) occurs in the battery module 20, a flame F and/or gas G may be discharged to the outside of the rack 10 through the flame removal module 400.

The flame F and/or gas G may be introduced into the flame removal module 400, a temperature thereof may be lowered by the flame prevention net 4000 disposed in the flame removal module 400, the flame may be removed, and then the gas G may be discharged to the outside of the flame removal module 400.

The flame removal module 400 may be provided as a plurality of flame removal modules 400, and the adjacent flame removal modules 400 may be connected to each other. Accordingly, the flame F and/or gas G may be introduced into one flame removal module 400 and move to another flame removal module 400 adjacent thereto.

The plurality of battery modules 20 may be connected to one flame removal module 400.

FIG. 5 is a perspective view illustrating a battery module of an energy storage system according to one or more embodiments of the present disclosure, and FIG. 6 is a cross-sectional view illustrating the battery module of the energy storage system according to one or more embodiments of the present disclosure.

A battery module 20, a flame removal module part 40, and a flame removal module 400 illustrated in FIGS. 5 and 6 are the same as the battery module 20, the flame removal module part 40, and the flame removal module 400 illustrated in FIGS. 1 to 4. Accordingly, the descriptions of the same components may be omitted.

Referring to FIGS. 5 and 6, an example layout of the battery module 20 and the flame removal module 400 is provided.

The battery module 20 may include a module case 210 and a module vent part 213.

The module case 210 may have a substantially hexahedral shape in which a space is formed. A battery cell 30 may be disposed in the module case 210. According to one or more embodiments, a plurality of battery cells 30 may be disposed in the module case 210.

The module case 210 may include a lower module case 211 and a module cover 212.

The lower module case 211 and the module cover 212 may be coupled. The module case 210 may include a module case hole 2100. The module case hole 2100 may be disposed in the lower module case 211 and/or the module cover 212. The inside and the outside of the module case 210 may communicate with each other (e.g., be in fluid communication with each other) through the module case hole 2100. Accordingly, air from outside of the module case 210 may be introduced into the inside thereof to cool the battery cell 30.

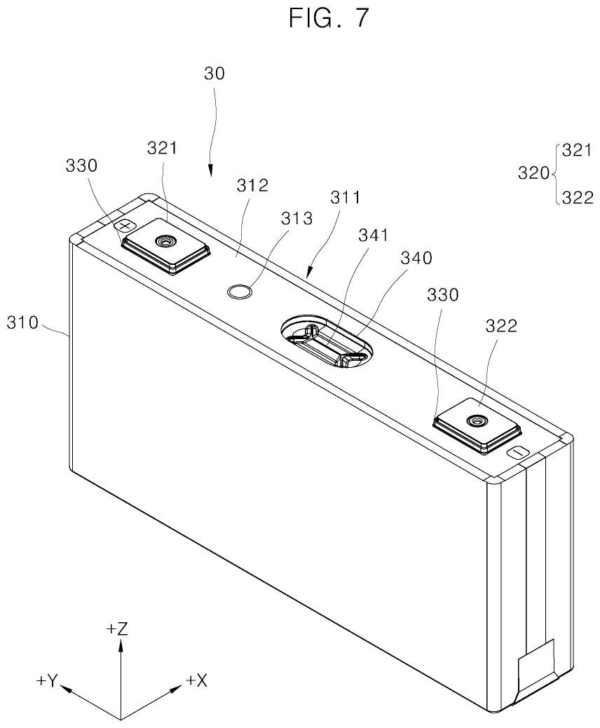

The module vent part 213 may be in contact with the battery cell 30 disposed in the module case 210. According to one or more embodiments, the module vent part 213 may be connected to a cell vent part (for example, a cell vent part 340 of FIG. 7) of the battery cell 30. The module vent part 213 may be connected to the cell vent part 340, and a flame F and/or gas G discharged through the cell vent part 340 may move to the module vent part 213. Accordingly, the flame F and/or gas G may not spread to other battery cells 30, and thermal runaway of the battery module 20 can be prevented.

The module vent part 213 may include a module vent passage 2131, a module vent coupling part 2132, and a module vent discharge part 2133.

The module vent coupling part 2132 and the module vent discharge part 2133 may be disposed in the module vent passage 2131.

The module vent coupling part 2132 may be connected to the cell vent part 340 of the battery cell 30 so that the flame F and/or gas G discharged through the cell vent part 340 may move to the module vent coupling part 2132. The module vent coupling part 2132 may be provided as a plurality of module vent coupling parts 2132, and each of the module vent coupling parts 2132 may be connected to the module vent passage 2131 and the cell vent part 340.

The flame F and/or gas G introduced through the module vent coupling part 2132 may move to the module vent passage 2131. The module vent passage 2131 may extend in one direction (for example, an X-axis direction). A cross-sectional shape of the module vent coupling part 2132 may be a circular shape or polygonal shape.

The module vent coupling part 2132 may be connected to the module vent discharge part 2133. The module vent discharge part 2133 may be connected to the flame removal module 400.

As described above, the module vent part 213 may be connected to the cell vent part 340 provided in each of the plurality of battery cells 30 to transfer the flame F and/or gas G generated in the battery cell 30 to the flame removal module 400.

FIG. 7 is a perspective view illustrating a battery cell disposed in an energy storage system according to one or more embodiments of the present disclosure. The battery cell 30 illustrated in FIG. 7 is the same as the battery cell 30 illustrated in FIGS. 1 to 6. Accordingly, the description of the same components may be omitted.

Referring to FIG. 7, the battery cell 30 may include a cell case 310 in which at least one electrode assembly, in which the positive electrode and the negative electrode are wound with an insulating separator interposed therebetween, is embedded and a cap assembly 311 coupled to an opening of the cell case 310.

Hereinafter, an example of the battery cell 30 which is a prismatic lithium-ion secondary battery will be described. However, in other embodiments, the battery cell 30 may be a lithium polymer battery or cylindrical battery.

The electrode assembly may have a roll form in which the positive electrode and the negative electrode are wound with the insulating separator interposed therebetween. However, in other embodiments, the electrode assembly may be formed as a stack structure in which a positive electrode and a negative electrode, which are formed of a plurality of sheets, are alternately stacked with a separator interposed therebetween.

The positive electrode and the negative electrode may include coating portions which are regions on which a current collector formed of a thin metal foil is coated with an active material and non-coating portions which are regions on which a current collector is uncoated with an active material.

The cell case 310 may form an overall exterior of the battery cell 30 and provide a space for accommodating the electrode assembly. The cell case 310 according to the present disclosure may have a rectangular parallelepiped shape with a hollow interior and an open side. The cell case 310 may be formed of a conductive metal material such as aluminum, an aluminum alloy, or steel plated with nickel.

An insulating part may be disposed on an outer portion of the cell case 310. The insulating part may be disposed on the outer portion of the cell case 310 such that adjacent battery cells 30 are spaced apart from each other without being in contact with each other. According to one or more embodiments, the insulating part may be attached to the cell case 310. The insulating part may include an insulating material such as rubber and resin.

The cap assembly 311 may be coupled to the cell case 310 and seal the cell case 310.

The cap assembly 311 according to the present disclosure may include a cap plate 312 which covers an opening of the cell case 310. The cap plate 312 may be formed of a conductive material. A positive terminal 321 and a negative terminal 322 electrically connected to the positive electrode or the negative electrode, respectively, may be installed to pass through and protrude outward from the cap plate 312.

A terminal part 320 may be disposed to protrude outward from the cap plate 312. The terminal part 320 may include the positive terminal 321 and the negative terminal 322. Upper outer peripheral surfaces of the positive terminal 321 and the negative terminal 322 may be threaded and fixed to the cap plate 312 by nuts.

However, in other embodiments, the positive terminal 321 and the negative terminal 322 may be formed as rivet structures and rivet-coupled or welding-coupled to the cap plate 312.

A terminal fixing part 330 may be disposed on an outer portion of the terminal part 320. The terminal fixing part 330 may be disposed on the outer portion of the terminal part 320 and may be in contact with the terminal part 320 to fix the terminal part 320.

An electrolyte injection hole 313 on which a sealing lid is installed may be formed in the cap plate 312.

A cell vent part 340 in which a notch 341 for performing an opening operation when an internal pressure of the cell case 310 rises may be installed in the cap plate 312. The cell vent part 340 may be connected to the module vent part 213 illustrated in FIG. 6.

The cell vent part 340 may be connected to and in communication with the module vent part 213. As the cell vent part 340 and the module vent part 213 are connected, when a fire occurs in the battery cell 30, a flame and/or gas may destroy the notch 341 and may be discharged through the cell vent part 340. The flame and gas discharged through the cell vent part 340 may move along the module vent part 213 connected to the cell vent part 340. The flame and gas may move to the flame removal module 400 along the module vent part 213.

The battery cell 30 may be disposed in a module case 210 of a battery module 20. The battery cell 30 according to the present disclosure may be disposed in the module case 210 such that the cap plate 312 faces a module cover 212.

The battery cell 30 may be provided as a plurality of battery cells 30. The plurality of battery cells 30 may be disposed in parallel in the module case 210. As an example, the plurality of battery cells 30 may be disposed in a direction parallel to an X-axis based on FIG. 6. The number of the battery cells 30 is not limited to the numbers illustrated in FIG. 6, and a design of the number may be variously changed according to a size and the like of the battery module 20.

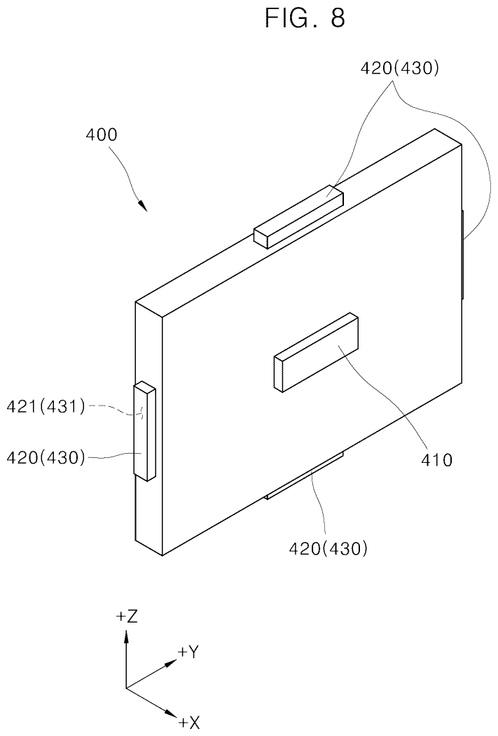

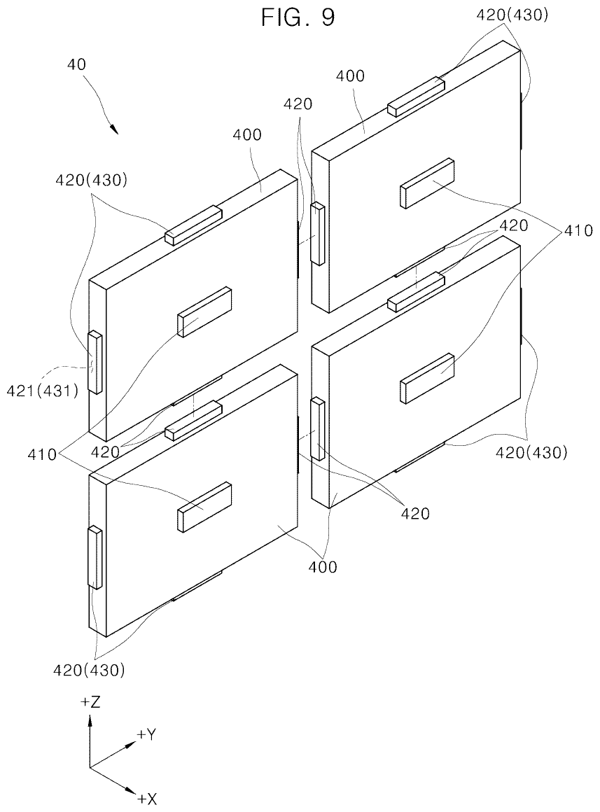

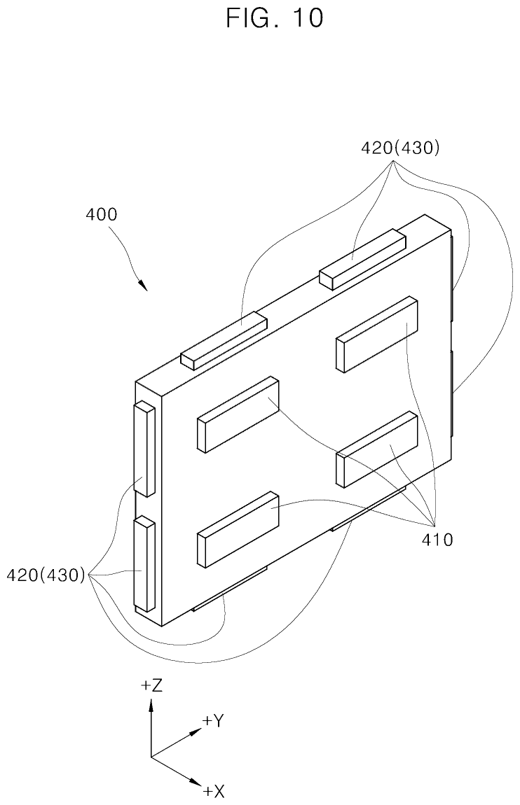

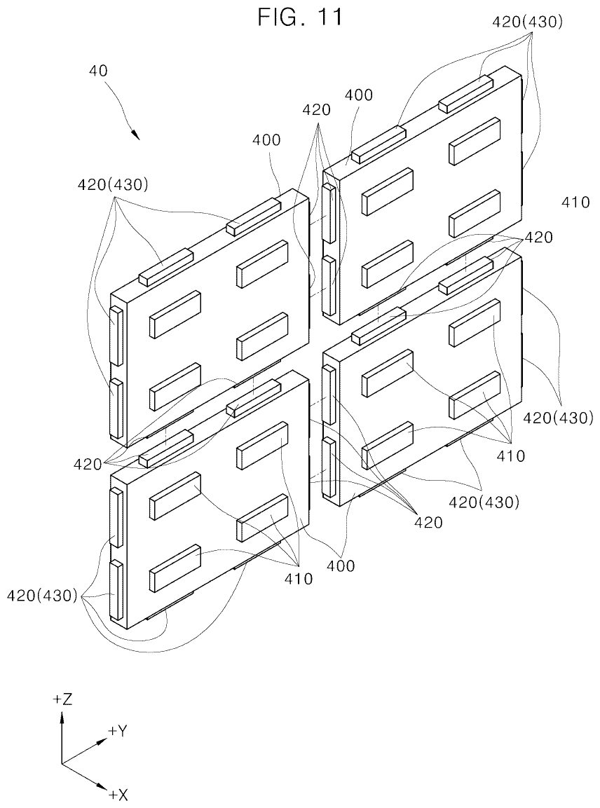

FIG. 8 is a perspective view illustrating a flame removal module according to a first embodiment of the present disclosure, and FIG. 9 is a perspective view illustrating a plurality of flame removal modules which are connected according to the first embodiment of the present disclosure. FIG. 10 is a perspective view illustrating a flame removal module according to a second embodiment of the present disclosure, and FIG. 11 is a perspective view illustrating a plurality of flame removal modules which are connected according to the second embodiment of the present disclosure.

In a flame removal module 400 of the first embodiment illustrated in FIGS. 8 and 9, one flame removal module 400 is connected to one battery module 20, and in a flame removal module 400 of the second embodiment illustrated in FIGS. 10 and 11, one flame removal module 400 is connected to a plurality of battery modules 20.

The flame removal module 400 may include a flame inlet 410, a flame connection part 420, and a flame outlet 430.

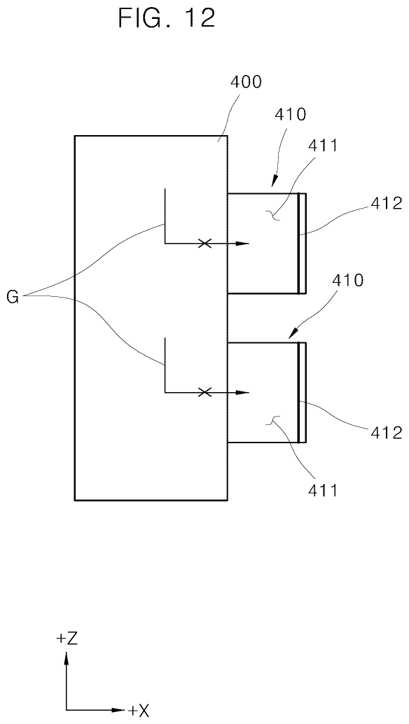

The flame inlet 410 may be disposed on a side surface (for example, in a +X-axis direction) of the flame removal module 400 and connected to the battery module 20. The flame inlet 410 may be connected to a module vent part 213 of the battery module 20. A flame F and/or gas G may move from the module vent part 213 to the flame inlet 410. The flame inlet 410 will be described below when FIGS. 12 to 14 are described.

The flame connection part 420 may be disposed on the flame removal module 400. The flame connection part 420 may connect one flame removal module 400 to another flame removal module 400. According to one or more embodiments, the flame connection part 420 disposed on one flame removal module 400 may be connected to the flame connection part 420 disposed on another flame removal module 400.

A plurality of flame removal modules 400 may communicate with each other through the flame connection parts 420, and accordingly, the flame F and/or gas G in one flame removal module 400 may move to other flame removal modules 400. As the flame F and/or gas G moves in the plurality of flame removal modules 400 as described above, the flame can be removed, and a temperature of the gas G can be lowered.

The flame connection parts 420 may include flame connection holes 421. The plurality of flame removal modules 400 connected through the flame connection holes 421 may communicate with each other.

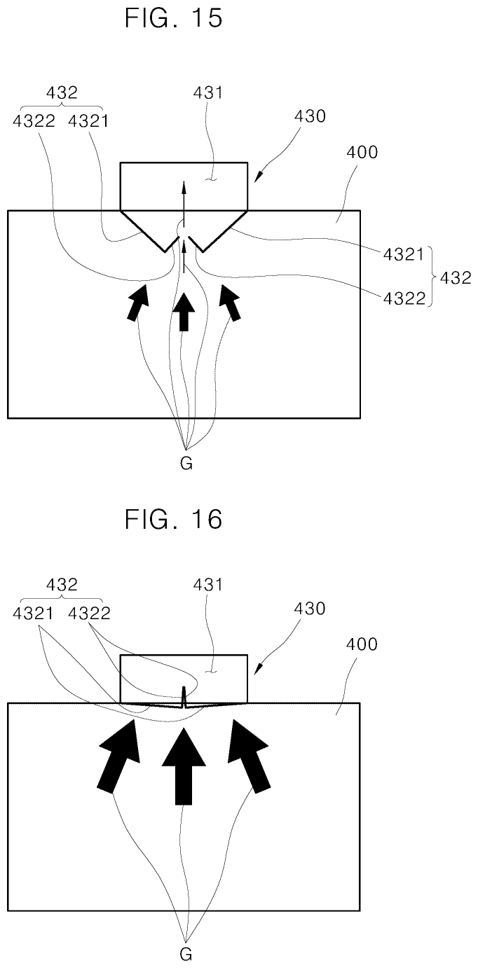

The flame outlet 430 may be disposed on the flame removal module 400. The flame outlet 430 may allow the inside and the outside of the flame removal module 400 to communicate with each other. Under a specific condition, the flame F and/or gas G in the flame removal module 400 may be discharged to the outside of the flame removal module 400 through the flame outlet 430. The flame outlet 430 will be described below when FIGS. 15 and 16 are described.

Locations at which the flame connection part 420 and the flame outlet 430 are disposed are not limited to those illustrated in FIGS. 8 to 12. The flame connection part 420 and the flame outlet 430 may be disposed at an upper side (for example, in a +Z-axis direction), a lower side (for example, a −Z-axis direction), a left side (for example, a −Y-axis direction), and a right side (for example, a +Y-axis direction) of the flame removal module 400. According to one or more embodiments, the flame connection part 420 and the flame outlet 430 may be disposed at a rear side (for example, a −X-axis direction) of the flame removal module 400.

Referring to FIGS. 8 and 9, one flame inlet 410 is disposed on one flame removal module 400. Accordingly, one flame removal module 400 may be connected to one battery module 20.

The plurality of flame removal modules 400 may be connected through the flame connection parts 420, and the flame F and/or gas G in the flame removal modules 400 may be discharged to the outside of the flame removal module 400 through the flame outlet 430.

Referring to FIGS. 10 and 11, a plurality of flame inlets 410 are disposed on one flame removal module 400. Accordingly, one flame removal module 400 may be connected to the plurality of battery modules 20. In FIGS. 10 and 11, four flame inlets 410 are disposed on one flame removal module 400. However, in other embodiments, the number of the flame inlets 410 disposed on the flame removal module 400 may vary.

A plurality of flame connection parts 420 and/or flame outlets 430 may be disposed on one surface of the flame removal module 400. In FIGS. 10 and 11, it is illustrated that two flame connection parts 420 and/or two flame outlets 430 are disposed on one surface of the flame removal module 400. However, in other embodiments, the number of flame connection parts 420 and/or the number of flame outlets 430 disposed on one surface may vary.

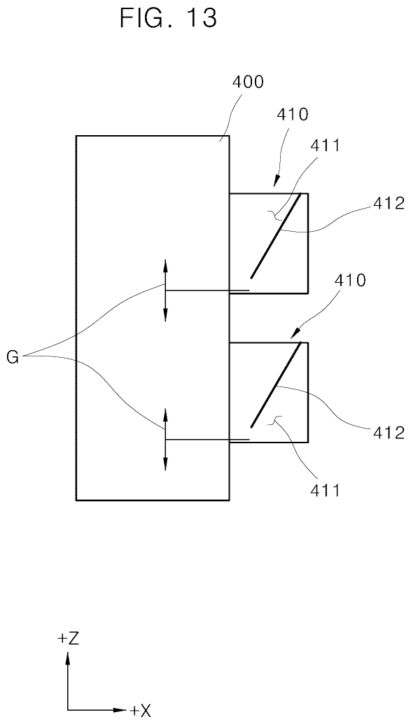

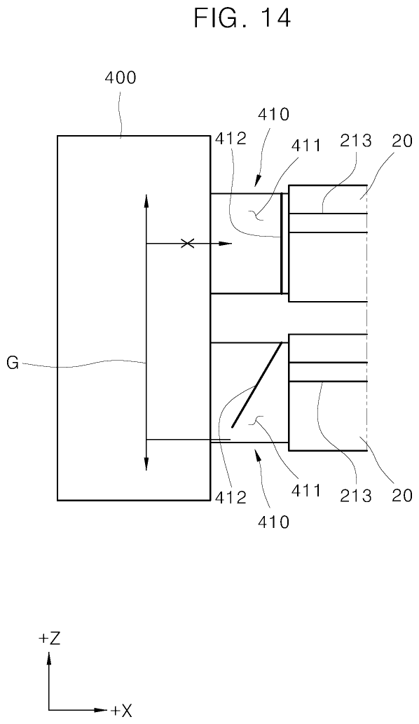

FIG. 12 is a cross-sectional view illustrating a flame inlet of a flame removal module which is closed according to one or more embodiments of the present disclosure, FIG. 13 is a cross-sectional view illustrating the flame inlet of the flame removal module which is opened according to one or more embodiments of the present disclosure, and FIG. 14 is a cross-sectional view illustrating the flame removal module connected to a battery module according to one or more embodiments of the present disclosure.

A flame removal module 400 and a flame inlet 410 illustrated in FIGS. 12 to 14 are the same as the flame removal module 400 and the flame inlet 410 illustrated in FIGS. 1 to 11. Accordingly, the descriptions of the same components may be omitted.

The flame inlet 410 may include a flame inflow hole 411 and a flame inflow gate 412.

The flame removal module 400 may be connected to a module vent part 213 through the flame inflow hole 411. Accordingly, a flame F and/or gas G may move from the module vent part 213 to the flame removal module 400 through the flame inflow hole 411. Although for figures after FIG. 2, only a “G” (for gas) is shown, it will be understood that a flame (“F”) could instead or additionally be present.

The flame inflow gate 412 may be disposed in the flame inflow hole 411. The flame inflow gate 412 may be disposed in the flame inflow hole 411 to limit a directionality of the flame F and/or gas G. According to one or more embodiments, the flame inflow gate 412 may be opened or closed.

Referring to FIG. 12, the flame inflow gate 412 closes the flame inflow hole 411. Referring to FIG. 13, the flame inflow gate 412 opens the flame inflow hole 411, and referring to FIG. 14, one flame inflow gate 412 is opened and another flame inflow gate 412 is closed.

The flame inflow gate 412 may allow the flame F and/or gas G to move from the module vent part 213 to the flame removal module 400, but block the flame F and/or gas G from moving from the flame removal module 400 to the module vent part 213. Accordingly, thermal runaway of a battery module 20 can be prevented by blocking the flame F and/or gas G from being introduced into the battery module 20.

One end of the flame inflow gate 412 may be fixed to the flame inflow hole 411, and the other end may not be fixed. Accordingly, the flame inflow gate 412 may rotate about one end thereof. The flame inflow gate 412 may move toward the flame removal module 400 (for example, in a −X-axis direction), but may not move toward the outside of (for example, in a +X-axis direction from) the flame removal module 400. Accordingly, the flame F and/or gas G may be prevented from being discharged to the outside of the flame removal module 400 through the flame inflow hole 411 by the flame inflow gate 412.

When an internal pressure of the flame removal module 400 is higher than an internal pressure of the module vent part 213, the flame inflow gate 412 may close the flame inflow hole 411.

When an internal pressure of the flame removal module 400 is lower than an internal pressure of the module vent part 213, the flame inflow gate 412 may open the flame inflow hole 411.

FIG. 15 is a cross-sectional view illustrating a flame outlet of a flame removal module which is opened according to one or more embodiments of the present disclosure, and FIG. 16 is a cross-sectional view illustrating the flame outlet of the flame removal module which is closed according to one or more embodiments of the present disclosure.

A flame removal module 400 and a flame outlet 430 illustrated in FIGS. 15 and 16 are the same as the flame removal module 400 and the flame outlet 430 illustrated in FIGS. 1 to 11. Accordingly, the descriptions of the same components may be omitted.

Referring to FIGS. 15 and 16, the flame outlet 430 may include a flame outflow hole 431 and a flame outflow gate 432.

The flame outflow hole 431 may allow the inside and the outside of the flame removal module 400 to communicate with each other. The flame outflow gate 432 may be disposed in the flame outflow hole 431.

The flame outflow gate 432 may open or close the flame outflow hole 431. If the flame outflow gate 432 is opened, the inside and the outside of the flame removal module 400 may communicate with each other through the flame outflow hole 431, and a fluid may move through the flame outflow hole 431. Accordingly, a flame F and/or gas G in the flame removal module 400 may be discharged to the outside of the flame removal module 400 through the flame outflow hole 431.

If the flame outflow gate 432 is closed, the fluid may not move through the flame outflow hole 431, and the flame F and/or gas G in the flame removal module 400 may not be discharged to the outside of the flame removal module 400.

The flame outflow gate 432 may be opened or closed according to an internal pressure of the flame removal module 400. According to one or more embodiments, the flame outflow gate 432 may be opened when an internal pressure of the flame removal module 400 is lower than a set pressure. According to one or more embodiments, the set pressure may range from about 1.1 bar to 2.0 bar.

When a fire does not occur in the battery module 20 and the battery module 20 operates normally, an internal pressure of the flame removal module 400 may not rise. When an internal pressure of the flame removal module 400 is lower than the set pressure, the flame outflow gate 432 may be opened, and the inside and the outside of the flame removal module 400 may communicate with each other through the flame outflow hole 431.

When a fire occurs in the battery module 20, a flame F and/or gas G may be generated and moved to the inside of the flame removal module 400, and accordingly, an internal pressure of the flame removal module 400 may rise. When the internal pressure of the flame removal module 400 rises to be higher than or equal to the set pressure, the flame outflow gate 432 may be closed, and the flame F and/or gas G may not be discharged to the outside of the flame removal module 400 through the flame outlet 430. The flame F and/or gas G may move to another flame removal module 400 connected through the flame connection part 420. While the flame F and/or gas G moves to the other flame removal module 400, the flame may be removed, and a temperature of the gas G may be lowered. In addition, while the flame F and/or gas G moves to the other flame removal module 400, an internal pressure of the flame removal module 400 may be lowered. When the internal pressure of the flame removal module 400 is lowered to be lower than the set pressure, the flame outflow gate 432 may be opened.

As described above, as the flame outflow gate 432 is closed at the set pressure or higher, the flame F and/or gas G may move to the other flame removal module 400 through the flame connection part 420, the flame of the flame F and/or gas G may be removed in the plurality of flame removal modules 400, and a temperature of the gas may be lowered.

Referring to FIG. 2, a flame F and/or gas G is not discharged from the flame removal module 400 connected to the battery module 20 in which a fire occurs and the flame F and/or gas G is discharged through the other flame removal module 400.

Accordingly, when a fire occurs in one battery module 20, as the plurality of flame removal modules 400 remove a flame and lower a temperature of a gas, a temperature rising due to the fire may be suppressed, and a temperature of the discharged gas can be lowered. In addition, flame deterrence of a flame removal module part 40 can be improved.

The flame outflow gate 432 may include a first flame outflow gate 4321 and a second flame outflow gate 4322. The first flame outflow gate 4321 and the second flame outflow gate 4322 may be provided as a plurality of first flame outflow gates 4321 and a plurality of second flame outflow gates 4322.

One end of the first flame outflow gate 4321 may be fixed to the flame outflow hole 431, and the other end thereof may not be fixed. Accordingly, the other end of the first flame outflow gate 4321 may rotate about one end thereof. The other end of the first flame outflow gate 4321 may be disposed toward the inside of the flame removal module 400.

The second flame outflow gate 4322 may be disposed on the other end of the first flame outflow gate 4321. One end of the second flame outflow gate 4322 may be fixed to the other end of the first flame outflow gate 4321. The other end of the second flame outflow gate 4322 may not be fixed.

When an internal pressure of the flame removal module 400 is lower than the set pressure, the first flame outflow gate 4321 and the second flame outflow gate 4322 may remain in an open state, and the inside and the outside of the flame removal module 400 may communicate with each other through the flame outflow hole 431 (see FIG. 15). Accordingly, a flame F and/or gas G may be discharged to the outside of the flame removal module 400.

When an internal pressure of the flame removal module 400 is higher than or equal to the set pressure, the first flame outflow gate 4321 and the second flame outflow gate 4322 may move to close the flame outflow hole 431 (see FIG. 16). Accordingly, the flame F and/or gas G may not be discharged to the outside of the flame removal module 400 and may move to the other flame removal module 400 through the flame connection part 420.

FIG. 17 is a perspective view illustrating a flame prevention net disposed in a flame removal module according to one or more embodiments of the present disclosure.

Referring to FIG. 17, a flame prevention net 4000 disposed in a flame removal module 400 may be confirmed.

The flame prevention net 4000 may include a mesh, a wire, and/or wool.

The materials of the mesh and the wire may include a metal. According to one or more embodiments, a material of the flame prevention net 4000 may include copper and/or stainless steel.

A specification of a mesh layer of the flame prevention net 4000 may range from about 10 meshes to 40 meshes.

The wool may include various materials such as mineral wool or glass wool.

The flame prevention net 4000 may include a structure in which the mesh, the wire, and the wool are stacked. According to one or more embodiments, in the flame prevention net 4000, a wire layer 4001, a mesh layer 4002, a wool layer 4003, another mesh layer 4002, and another wire layer 4001 may be sequentially stacked.

The wire layers and the mesh layers may absorb heat to lower a temperature of a flame F and/or gas G, and the wool layer may suppress movement of the flame.

As the flame prevention net 4000 includes the mesh, the wire, and the wool, the flame prevention net 4000 may remove the flame and lower a temperature of the gas of the flame F and/or gas G.

Damage to a battery module due to a fire can be minimized in an energy storage system according to the present disclosure.

In addition, a flame generated in the battery module can be removed in the energy storage system according to the present disclosure.

In addition, thermal runaway of the battery module can be prevented in the energy storage system according to the present disclosure.

However, the effects obtainable through the present disclosure are not limited to the above effects, and other technical effects that are not mentioned will be clearly understood by those of ordinary skill in the art from the following description of the present disclosure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An energy storage system, comprising:
a rack;
a battery module in the rack, the battery module including a module case and a module vent part;
a plurality of battery cells in the module case, each of the plurality of battery cells including a cell vent part which communicates with the module vent part; and
a flame removal module part in the rack, the flame removal part including a flame removal module which communicates with the module vent part.

2. The energy storage system as claimed in claim 1, wherein the battery module includes a module case hole provided as an opening passing through the module case, the module case hole being blocked from the module vent part.

3. The energy storage system as claimed in claim 1, wherein the module vent part includes:
a module vent coupling part which communicates with the cell vent part;
a module vent passage which communicates with the module vent coupling part; and
a module vent discharge part on an end portion of the module vent passage, the module vent discharge part in communication with the flame removal module.

4. The energy storage system as claimed in claim 1, wherein:
the battery module includes a plurality of battery modules; and
the flame removal module part communicates with the module vent part included in each of the plurality of battery modules.

5. The energy storage system as claimed in claim 1, wherein the flame removal module part includes:
a flame inlet which communicates with the module vent part; and
a flame connection part which communicates with the flame inlet.

6. The energy storage system as claimed in claim 5, wherein:
the flame removal module part includes a plurality of flame removal modules; and
adjacent flame removal modules communicate with each other through the flame connection part.

7. The energy storage system as claimed in claim 5, wherein the flame inlet includes:
a flame inflow hole through which a fluid moves from the module vent part to the flame removal module; and
a flame inflow gate which opens or closes the flame inflow hole.

8. The energy storage system as claimed in claim 7, wherein the flame inflow gate blocks the fluid from moving from the flame removal module to the module vent part.

9. The energy storage system as claimed in claim 5, wherein the flame removal module includes a flame outlet which communicates with the flame inlet and the flame connection part, the flame outlet discharging a fluid to an outside of the flame removal module.

10. The energy storage system as claimed in claim 9, wherein the flame outlet includes:
a flame outflow hole through which the fluid is discharged to the outside of the flame removal module; and
a flame outflow gate which opens or closes the flame outflow hole.

11. The energy storage system as claimed in claim 10, wherein the flame outflow gate opens the flame outflow hole when an internal pressure of the flame removal module is lower than a set pressure and closes the flame outflow hole when an internal pressure of the flame removal module is higher than or equal to the set pressure.

12. The energy storage system as claimed in claim 11, wherein the set pressure is 1.1 bar.

13. The energy storage system as claimed in claim 5, wherein the flame removal module part includes a flame prevention net in the flame removal module to remove a flame.

14. The energy storage system as claimed in claim 13, wherein the flame prevention net is in the flame inlet which communicates with the module vent part.

15. The energy storage system as claimed in claim 13, wherein:
the flame removal module includes a plurality of flame removal modules; and
the flame prevention net is in the flame connection part through which adjacent flame removal modules communicate with each other.

16. The energy storage system as claimed in claim 13, wherein the flame prevention net is in a flame outlet through which an inside and an outside of the flame removal module communicate with each other.
